(19) United States
(12) Patent Application Publication
(10) Pub. No.: US 2017/0285384 A1
(43) Pub. Date: Oct. 5, 2017

(54) LIQUID CRYSTAL DISPLAY DEVICE AND LIQUID CRYSTAL DISPLAY SYSTEM

(71) Applicant: Japan Display Inc., Tokyo (JP)

(72) Inventors: Tatsuya Yata, Tokyo (JP); Masaya Tamaki, Tokyo (JP)

(21) Appl. No.: 15/474,056

(22) Filed: Mar. 30, 2017

(30) Foreign Application Priority Data
Mar. 31, 2016 (JP) 2016-071715

(51) Int. Cl. G02F 1/1335; G02F 1/1362; G02F 1/1368; G02F 1/13363

(52) U.S. Cl. CPC G02F 1/13362; G02F 1/13363; G02F 1/133504; G02F 1/136286; G02F 1/1368; G02F 1/133528; G02F 1/133553; G02F 2001/133531; G02F 2201/123; G02F 2001/133638; G02F 2413/02; G02F 2413/05; G02F 2001/133616

(57) ABSTRACT

According to one embodiment, a liquid crystal display device includes an optical member including a polarizer having an absorption axis and a transmission axis, a liquid crystal display panel including a light-reflecting layer and a liquid crystal layer located between the light-reflecting layer and the optical member, and a lighting unit located on a side opposite to the optical member with respect to the liquid crystal display panel to release linearly polarized light transmitted through the polarizer toward the polarizer side.

### CROSS-REFERENCE TO RELATED APPLICATIONS

This application is based upon and claims the benefit of priority from Japanese Patent Application No. 2016-071715, filed Mar. 31, 2016, the entire contents of which are incorporated herein by reference.

### FIELD

Embodiments described herein relate generally to a liquid crystal display device and a liquid crystal display system.

### BACKGROUND

Recently, attention has been focused on reflective liquid crystal display devices as display devices. The liquid crystal display devices can be made thinner since they do not need a backlight unit. If the liquid crystal display devices use a backlight unit, thermal influence which may be given to a liquid crystal display panel does not need to be considered.

### BRIEF DESCRIPTION OF THE DRAWINGS

FIG. 1 is a longitudinally cross-sectional view showing a liquid crystal display device of a first embodiment.

FIG. 2 is a plan view showing several parts of the liquid crystal display device, illustrating a liquid crystal display panel, a signal line drive circuit, a control module, and a connection module.

FIG. 3 is a schematically cross-sectional view showing several parts of the liquid crystal display panel.

FIG. 4 is a plan view showing an array substrate shown in FIG. 2 and FIG. 3.

FIG. 5 is an equivalent circuit diagram showing a unit pixel shown in FIG. 4.

FIG. 6 is an enlarged cross-sectional view showing several parts of the liquid crystal display panel.

FIG. 7 is a cross-sectional view showing the liquid crystal display panel and an optical member of the liquid crystal display device.

FIG. 8 is an illustration for explanation of an optical path in the optical member and the liquid crystal display panel of the liquid crystal display device.

FIG. 9 is a cross-sectional view showing example 1 of a lighting unit shown in FIG. 1.

FIG. 10 is a cross-sectional view showing example 2 of the lighting unit shown in FIG. 1.

FIG. 11 is a cross-sectional view showing example 3 of the lighting unit shown in FIG. 1.

FIG. 12 is a front view showing the liquid crystal display device, illustrating linearly polarized light released from the lighting unit, an absorption axis and a transmission axis of a polarizer, and the like.

FIG. 13 is a cross-sectional view showing a lighting unit, an optical member and a liquid crystal display panel of a liquid crystal display device of a comparative example, for explanation of variation in energy of the light released from the lighting unit of the comparative example.

FIG. 14 is a cross-sectional view showing the lighting unit, the optical member and the liquid crystal display panel of the liquid crystal display device of the embodiment, for explanation of variation in energy of the light released from the lighting unit of the embodiment.

FIG. 15 is a graph showing variation in a light reflectance at an incident angle on an arbitrary medium.

FIG. 16 is a cross-sectional view showing several parts of an array substrate in a liquid crystal display device of a second embodiment, illustrating a fifth insulating film, a pixel electrode, an alignment film and a liquid crystal layer.

FIG. 17 is a cross-sectional view showing a liquid crystal display panel and an optical member in the liquid crystal display device of the second embodiment.

FIG. 18 is a front view showing a liquid crystal display device of a third embodiment, illustrating linearly polarized light released from a lighting unit, an absorption axis and a transmission axis of a polarizer, and the like.

FIG. 19 is a cross-sectional view showing a liquid crystal display panel and an optical member in a liquid crystal display device of a fourth embodiment.

FIG. 20 is a cross-sectional view showing a liquid crystal display panel and an optical member in a liquid crystal display device of a fifth embodiment.

FIG. 21 is a cross-sectional view showing a second light diffusion film shown in FIG. 20.

FIG. 22 is a cross-sectional view showing a liquid crystal display panel and an optical member in a liquid crystal display device of a sixth embodiment.

FIG. 23 is a longitudinally cross-sectional view showing modified example 1 of the liquid crystal display device of the first embodiment.

FIG. 24 is a longitudinally cross-sectional view showing modified example 2 of the liquid crystal display device of the first embodiment.

FIG. 25 is a longitudinally cross-sectional view showing modified example 3 of the liquid crystal display device of the first embodiment.

FIG. 26 is a front view showing several parts of modified example 4 of the liquid crystal display device of the first embodiment.

FIG. 27 is a front view showing several parts of modified example 5 of the liquid crystal display device of the first embodiment.

FIG. 28 is a front view showing modified example 6 of the liquid crystal display device of the first embodiment.

FIG. 29 is a front view showing modified example 7 of the liquid crystal display device of the first embodiment.

### DETAILED DESCRIPTION

In general, according to one embodiment, there is provided a liquid crystal display device comprising: an optical member comprising a polarizer having an absorption axis and a transmission axis; a liquid crystal display panel including a light-reflecting layer and a liquid crystal layer located between the light-reflecting layer and the optical member; and a lighting unit located on a side opposite to the optical member with respect to the liquid crystal display panel to release linearly polarized light transmitted through the polarizer toward the polarizer side.

Embodiments will be described hereinafter with reference to the accompanying drawings. The disclosure is a mere example, and arbitrary change of gist which can be easily conceived by a person of ordinary skill in the art naturally falls within the inventive scope. To more clarify the explanations, the drawings may pictorially show width, thickness, shape, etc. of each portion as compared with an actual aspect, but they are mere examples and do not restrict the interpretation of the invention. In the present specification and drawings, elements like or similar to those in the already described drawings may be denoted by similar reference numbers and their detailed descriptions may be arbitrarily omitted.

### First Embodiment

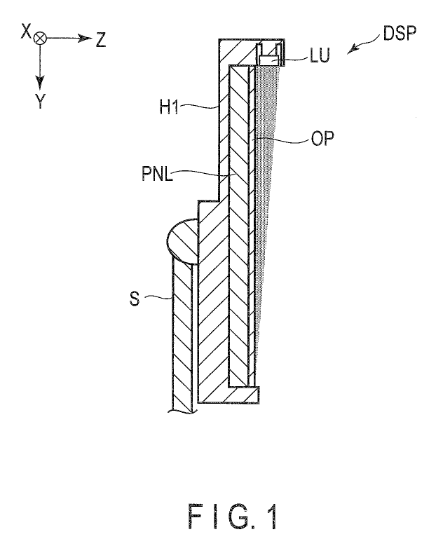

First, a liquid crystal display device of a first embodiment will be explained in detail. FIG. 1 is a longitudinally cross-sectional view showing a liquid crystal display device DSP of the first embodiment.

As shown in FIG. 1, the liquid crystal display device DSP comprises an optical member OP, a liquid crystal display panel PNL, a lighting unit LU, a housing H1, and a stand S. The stand S holds the housing H1.

Details of the optical member OP will be explained later, but the optical member OP comprises a polarizer having at least an absorption axis and a transmission axis. The optical member OP is located on a display surface side of the liquid crystal display panel PNL. In the present embodiment, the optical member OP is disposed on a display surface of the liquid crystal display panel PNL. Details of the liquid crystal display panel PNL will be explained later, but the liquid crystal display panel PNL includes at least a light-reflecting layer and a liquid crystal layer located between the light-reflecting layer and the optical member OP.

The lighting unit LU is located on a side opposite to the optical member OP with respect to the liquid crystal display panel PNL. In other words, the lighting unit LU is located on a side of the optical member OP which does not face the liquid crystal display panel PNL. The lighting unit LU may be located remote from the optical member OP or may be in contact with the optical member OP. For this reason, the lighting unit LU may be called a front light unit. Details of the lighting unit LU will be explained later, but the lighting unit LU is configured to release linearly polarized light which is transmitted through the polarizer of the optical member OP to the polarizer side. For this reason, the linearly polarized light released from the lighting unit LU is made incident on the liquid crystal display panel PNL after having transmitted through the polarizer of the optical member OP.

The optical member OP, the liquid crystal display panel PNL and the lighting unit LU are accommodated in the housing H1 and their relative positions are fixed. In the present embodiment, the lighting unit LU is disposed on an upper part of the housing H1 which is the upper front side of the optical member OP. For this reason, the lighting unit LU is configured to release the linearly polarized light in a downward direction and illuminate the liquid crystal display panel PNL. The upper part of the housing H1 indicates a portion of the housing H1 located in a direction opposite to the second direction Y with respect to the liquid crystal display panel PNL. The downward direction indicates a direction proceeding from the lighting unit LU to the front side of the second direction Y and a direction proceeding from the lighting unit LU to the optical member OP.

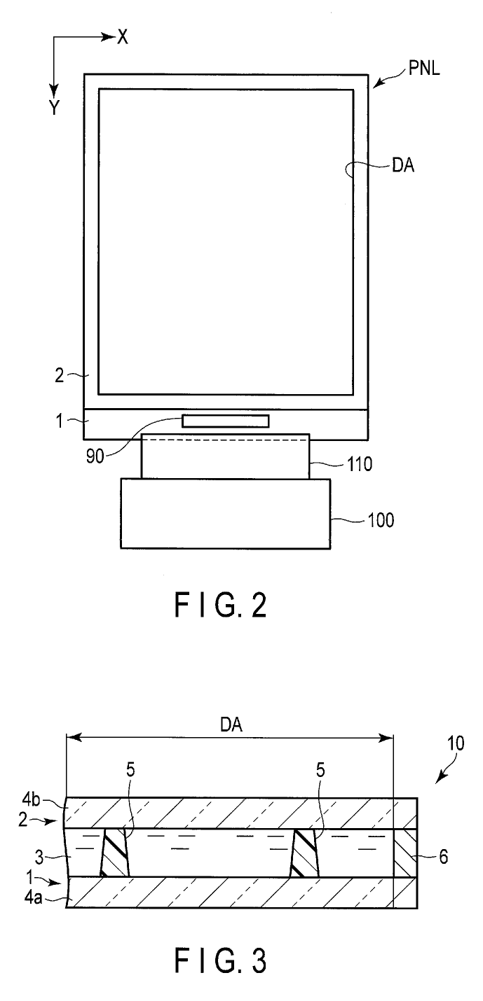

FIG. 2 is a plan view showing several parts of the liquid crystal display device DSP, illustrating the liquid crystal display panel PNL, a signal line drive circuit 90, a control module 100, and a connection module 110. FIG. 3 is a schematically cross-sectional view showing several parts of the liquid crystal display panel PNL.

As shown in FIG. 2 and FIG. 3, the liquid crystal display device DSP comprises the liquid crystal display panel PNL. In the present embodiment, the liquid crystal display panel PNL adopts the twisted nematic (TN) mode. The liquid crystal display panel PNL comprises an array substrate 1, a counter-substrate 2 opposed to the array substrate with a predetermined gap between the array substrate 1 and the counter-substrate 2, and a liquid crystal layer 3 held between the substrates. Besides these, the liquid crystal display device DSP comprises a signal line drive circuit 90 serving as a video signal output module, a controller 100, and a connection module 110. A flexible printed circuit (FPC) or a tape carrier package (TCP) can be used as the connection module 110. The liquid crystal display panel PNL includes a display area DA. The display area DA is surrounded by a non-display area.

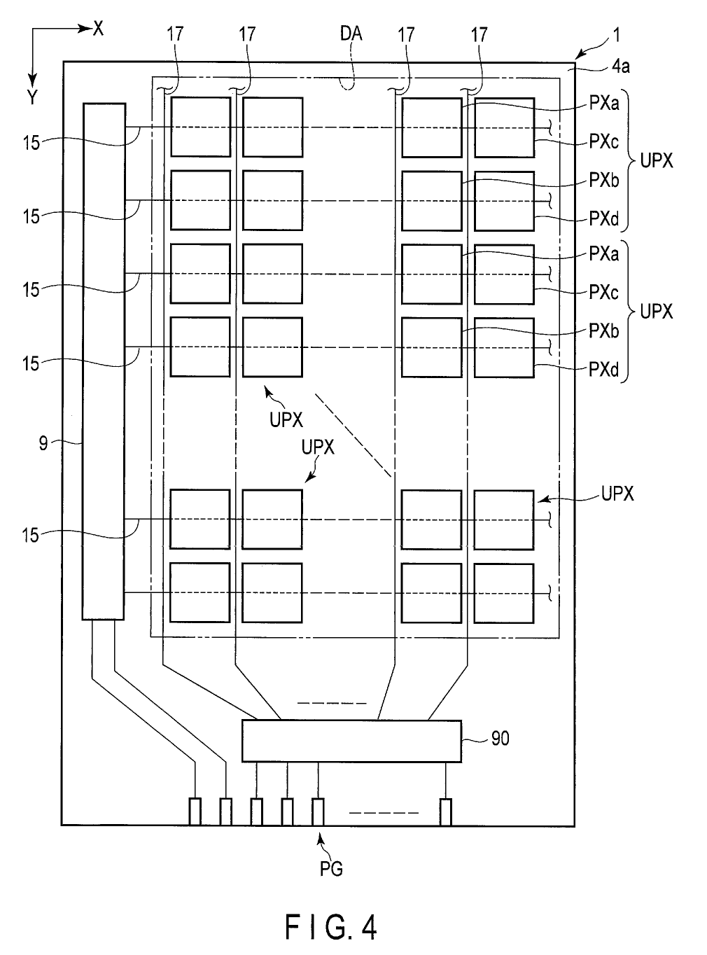

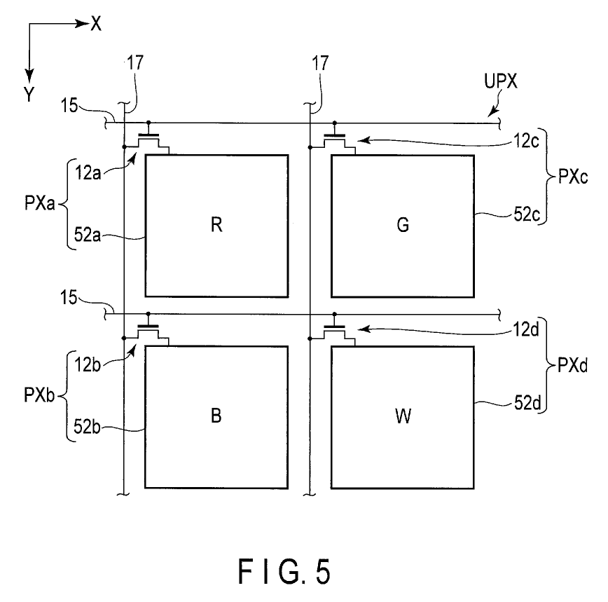

FIG. 4 is a plan view showing the array substrate 1 shown in FIG. 2 and FIG. 3. FIG. 5 is an equivalent circuit diagram showing a unit pixel UPX shown in FIG. 4.

As shown in FIG. 2 to FIG. 5, the array substrate 1 includes, for example, a glass substrate 4a as a transparent insulating substrate. The unit pixels UPX are arrayed in a matrix above the glass substrate 4a, in the display area DA.

Each of the unit pixels UPX comprises pixels PX. Each of the unit pixels UPX comprises first to fourth pixels PXa to PXd. The second pixel PXb is located adjacent to the first pixel PXa in the second direction Y. The third pixel PXc is located adjacent to the first pixel PXa in the first direction X. The fourth pixel PXd is located adjacent to the second pixel PXb in the first direction X and located adjacent to the third pixel PXc in the second direction Y. In the present embodiment, the first direction X and the second direction Y are orthogonal to each other but are not limited to this and may intersect at an angle other than 90°. A third direction Z is orthogonal to the first direction X and the second direction Y.

The unit pixels UPX may be restated as picture elements. Alternatively, the unit pixels UPX may be restated as pixels and, in this case, the pixels PX may be restated as sub-pixels. The alignment of the pixels PX explained here is a mere example and can be variously modified.

A drive circuit 9 and an outer lead bonding pad group (hereinafter referred to as an OLB pad group) PG are formed above the glass substrate 4a, outside the display area DA. In the present embodiment, the drive circuit 9 is used as a scanning line drive circuit.

In the present specification described below, when a second member located on a first member or a second member located above a first member is mentioned, the second member may be in contact with the first member or may be not in contact with the first member. In the latter case, a third member may be interposed between the first member and the second member. In the display area DA, scanning lines 15 and signal lines 17 are disposed above the glass substrate 4a. The signal lines 17 are connected to the signal line drive circuit 90. The signal lines 17 extend in the second direction Y and spaced apart from each other in the first direction X. The signal lines 17 are electrically connected to aligned pixels PX, respectively. The scanning lines 15 are connected to the drive circuit 9 (scanning line drive circuit). The scanning lines 15 extend in the first direction X and spaced apart from each other in the second direction Y. The scanning lines 15 are electrically connected to aligned pixels PX, respectively.

Next, one of the unit pixels UPX will be extracted and described.

As shown in FIG. 4 and FIG. 5, the first to fourth pixels PXa to PXd are pixels of different colors. In the present embodiment, the first to fourth pixels PXa to PXd are the pixels of red color (R), green color (G), blue color (B) and white color (W). The unit pixel UPX is composed of what is called RGBW square pixels (i.e., pixels formed by arraying four RGBW square pixels, in square). Unlike the present embodiment, however, the pixel PX may have a shape such as a rectangle, other than a square. The areas of the first to fourth pixels PXa to PXd may be different from each other. The unit pixel UPX may not be composed of pixels PX of four colors of RGBW, but can be variously modified. For example, the unit pixel UPX may be composed of pixels PX of three colors of RGB or pixels PX of the other colors.

The first pixel PXa is the red (R) pixel comprising a first pixel electrode 52a and a first switching element 12a. In the present embodiment, the first switching element 12a is formed of a thin-film transistor (TFT). The first switching element 12a comprises a first electrode electrically connected to the scanning line 15, a second electrode electrically connected to the signal line 17, and a third electrode electrically connected to the first pixel electrode 52a. In the first switching element 12a, the first electrode functions as a gate electrode, either of the second electrode and the third electrode functions as a source electrode, and the other of the second electrode and the third electrode functions as a drain electrode. The functions of the first to third electrodes are the same as those of second to fourth switching elements 12b to 12d to be explained later.

The second pixel PXb is the blue (B) pixel comprising a second pixel electrode 52b and a second switching element 12b. The second pixel PXb is connected to the same signal line 17 as the signal line to which the first pixel PXa is connected.

The third pixel PXc is the green (G) pixel comprising a third pixel electrode 52c and a third switching element 12c. The third pixel PXc is connected to the same scanning line 15 as the signal line to which the first pixel PXa is connected.

The fourth pixel PXd is the white (W) pixel comprising a fourth pixel electrode 52d and a fourth switching element 12d. The fourth pixel PXd is connected to the same scanning line 15 as the signal line to which the second pixel PXb is connected and the same signal line 17 as the signal line to which the third pixel PXc is connected.

In the present embodiment, as explained above, two signal lines 17 and two scanning lines 15 are connected to each of the unit pixels UPX. However, four signal lines 17 and one scanning line 15 may be connected to each unit pixel UPX. In this case, the first to fourth pixels PXa to PXd of the unit pixel UPX are electrically connected to the same scanning line 15. The first to fourth pixels PXa to PXd of the unit pixel UPX are electrically connected to the different signal lines 17.

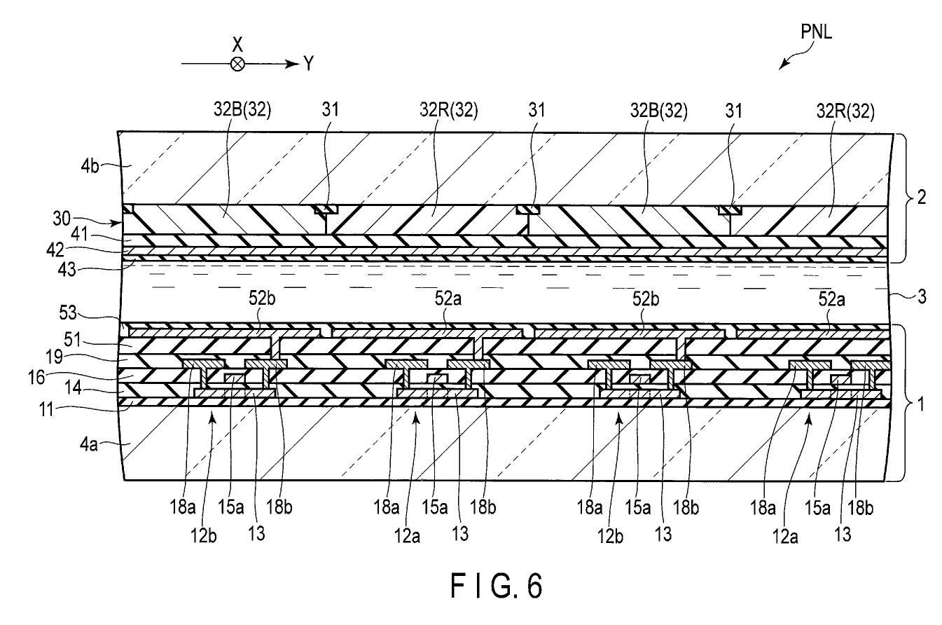

Next, a cross-sectional structure of the liquid crystal display panel PNL will be explained. FIG. 6 is an enlarged cross-sectional view showing several parts of the liquid crystal display panel PNL.

As shown in FIG. 6, a first insulating film 11 is disposed on the glass substrate 4a. Switching elements 12 (12a to 12d) are disposed above the first insulating film 11.

More specifically, a semiconductor layer 13 is disposed on the first insulating film 11. In other words, the semiconductor layer 13 is located on the liquid crystal layer 3 side of the first insulating film 11. The second insulating film 14 is disposed on the first insulating film 11 and the semiconductor layer 13. The scanning lines 15 are disposed on the second insulating film 14. The scanning lines 15 include first electrodes (gate electrodes) 15a opposed to first areas (channel areas) of the semiconductor layer 13. A third insulating film 16 is disposed on the second insulating film 14 and the scanning lines 15 (first electrodes 15a).

The signal lines 17, second electrodes 18a and third electrodes 18b are disposed on the third insulating film 16. The signal lines 17, the second electrodes 18a and the third electrodes 18b are simultaneously formed of the same material. The signal lines 17 are formed integrally with the second electrodes 18a. The second electrodes 18a are in contact with second regions of the semiconductor layer 13 through contact holes formed in the second insulating film 14 and the third insulating film 16. The third electrodes 18b are in contact with third regions of the semiconductor layer 13 through the other contact holes formed in the second insulating film 14 and the third insulating film 16. The second regions or the third regions function as source regions while the other regions of the second regions and the third regions function as drain regions. The switching elements 12 are formed as described above.

A fourth insulating film 19 is formed on the third insulating film 16, the signal lines 17, the second electrodes 18a and the third electrodes 18b. A fifth insulating film 51 is disposed on the fourth insulating film 19. In the present embodiment, the first insulating film 11, the second insulating film 14, the third insulating film 16, and the fourth insulating film 19 are formed of an inorganic insulating material, and the fifth insulating film 51 is formed of an organic insulating material. Each of the first to fifth insulating films may be formed of an electrically insulating material and may be formed of any material of the inorganic and organic insulating materials.

Pixel electrodes 52 (52a to 52d) are formed on the fifth insulating film 51. Each of the pixel electrodes 52 is formed of a light-reflecting conductive layer, a transparent conductive layer or a laminate of these layers. The light-reflecting conductive layer can be formed of a metal material such as aluminum (Al) or the like. The transparent conductive layer can be formed of a transparent conductive material such as indium tin oxide (ITO) and indium zinc oxide (IZO).

In the present embodiment, the pixel electrode 52 is a light-reflective pixel electrode formed of a laminate of a light-reflecting conductive layer and a transparent conductive layer. The liquid crystal display panel PNL is a light-reflective liquid crystal display panel. The pixel electrode 52 also functions as a light-reflecting layer, and can reflect light incident from the side of the display surface (outer surface of the counter-substrate 2) to the display surface side.

For example, the transparent conductive layer is located at a top of the pixel electrode 52. The transparent conductive layer may be the same in size as the light-reflecting conductive layer and may be disposed to be completely overlaid on the light-reflecting conductive layer. In this case, the light-reflecting conductive layer and the transparent conductive layer can be formed simultaneously by patterning the stacked light-reflecting conductive film and transparent conductive film, in one photolithographic process.

In addition, in the present embodiment, the pixel electrode 52 has a flat light-reflecting surface on the side opposed to the liquid crystal layer 3. However, the pixel electrode 52 may have an uneven light-reflecting surface, unlike the present embodiment. The pixel electrode 52 may be formed without a transparent conductive layer, unlike the present embodiment.

If the pixel electrode 52 is formed of the transparent conductive layer alone and has a light transmitting property, the liquid crystal display panel PNL may comprise the light-reflecting layer separately from the pixel electrode 52. In this case, the pixel electrode 52 is located between the light-reflecting layer and the liquid crystal layer 3.

An alignment film 53 is formed on the fifth insulating film 51 and the pixel electrodes 52. The alignment film 53 is in contact with the liquid crystal layer 3.

The array substrate 1 is formed as described above.

In contrast, the counter-substrate 2 includes, for example, a glass substrate 4b as the transparent insulating substrate. A color filter 30 is disposed on the side of the glass substrate 4b which is opposed to the array substrate 1. The color filter 30 includes a black matrix 31 and color layers (or uncolored layers) 32. The black matrix 31 is formed in a lattice shape to partition the pixels PX. However, the color filter 30 may be formed without the black matrix 31, unlike the present embodiment. The black matrix 31 may be formed in not a lattice shape, but a stripe shape. The black matrix 31 in the stripe shape may be called a stripe-shaped light-shielding portion.

In the present embodiment, the color filter 30 includes a red-colored layer 32 (32R) forming a first pixel PXa, a blue-colored layer 32 (32B) forming a second pixel PXb, a green-colored layer 32 forming a third pixel PXc, and a transparent uncolored layer 32 forming a fourth pixel PXd. The color filter 30 can be formed without the uncolored layers 32. In addition, the fourth pixel PXd may include light-colored layers instead of the transparent uncolored layers 32. If the fourth pixel PXd is a pixel of a color other than white, unlike the present embodiment, the fourth pixel PXd may include a layer of the corresponding color.

In addition, in the present embodiment, an overcoat film 41 is formed on the side of the color filter 30 which is opposed to the array substrate 1. The overcoat film 41 has a function of reducing unevenness on the surface of the side of the counter-substrate 2 which is in contact with the liquid crystal layer 3 and may be disposed as needed. A counter-electrode (common electrode) 42 and an alignment film 43 are disposed in order on the side of the overcoat film 41 which is opposed to the array substrate 1.

In the present embodiment, the counter-electrode 42 is formed of a transparent conductive material such as ITO and IZO. The alignment film 43 is in contact with the liquid crystal layer 3.

The counter-substrate 2 is formed as described above.

As shown in FIG. 3, the gap between the array substrate 1 and the counter-substrate 2 is held by columnar spacers 5. The array substrate 1 and the counter-substrate 2 are bonded to each other by a sealing member 6 disposed at peripheral portions of both the substrates. The liquid crystal layer 3 is disposed in a space surrounded by the array substrate 1, the counter-substrate 2 and the sealing member 6. In the present embodiment, the liquid crystal layer 3 is formed of a positive liquid crystal material.

The liquid crystal display panel PNL is configured as described above.

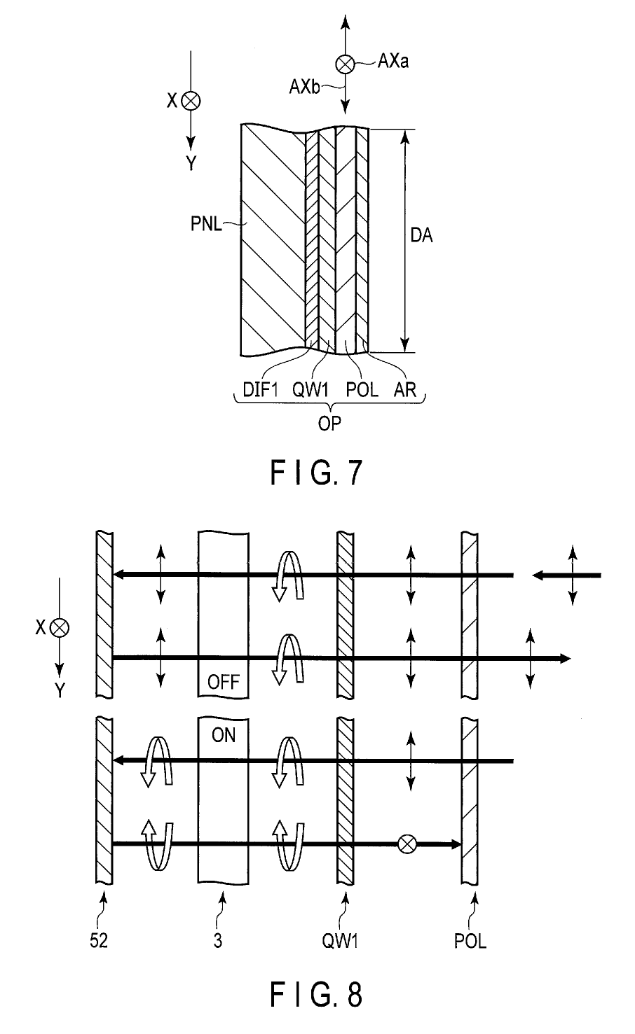

FIG. 7 is a cross-sectional view showing the liquid crystal display panel PNL and optical member OP of the liquid crystal display device DSP.

As shown in FIG. 7, the optical member OP is opposed to at least the display area DA of the liquid crystal display panel PNL. The optical member OP comprises a light diffusion film DIF1 serving as a first light diffusion film, a λ/4-wave plate QW1 serving as a first λ/4-wave plate, a polarizer POL, and an anti-reflective layer AR.

The light diffusion film DIF1 is located between the polarizer POL and the liquid crystal display panel PNL. In the present embodiment, the light diffusion film DIF1 is formed of an anisotropic diffusion layer. However, the light diffusion film DIF1 may be formed of an isotropic diffusion layer, unlike the present embodiment. The light reflected on the liquid crystal display panel PNL can be diffused and emitted to the λ/4-wave plate QW1 side by using the light diffusion film DIF1.

The λ/4-wave plate QW1 is located between the polarizer POL and the liquid crystal display panel PNL (light diffusion film DIF1). The λ/4-wave plate QW1 shifts a phase of the linearly polarized light incident from the polarizer POL, by a quarter wavelength, and urges the light to be emitted to the liquid crystal display panel PNL as circularly polarized light. The polarizer POL has an absorption axis AXa and a transmission axis AXb. In the present embodiment, the absorption axis AXa is parallel to the first direction X, and the transmission axis AXb is parallel to the second direction Y.

The anti-reflective layer AR is located at the position farthest from the liquid crystal display panel PNL, of the optical member OP. The anti-reflective layer AR is a layer on which the linearly polarized light released from the lighting unit LU or environmental light such as external light is made incident first, and suppresses reflection of the light.

The optical member OP is stuck on the liquid crystal display panel PNL by an adhesive layer (not shown). In the optical member OP, too, the light diffusion film DIF1, the λ/4-wave plate QW1, the polarizer POL, and the anti-reflective layer AR are integrally formed by using an adhesive layer (not shown). For this reason, an air layer is not formed between the optical member OP and the liquid crystal display panel PNL or inside the optical member OP, in the present embodiment.

The optical member OP is configured as explained above.

Next, an example of an optical path of the liquid crystal display device DSP will be explained. In this example, the liquid crystal display panel PNL uses a normally-white mode. The normally-white mode is a mode in which the liquid crystal display panel PNL becomes white display in the off status of applying no voltage to the liquid crystal layer 3.

FIG. 8 is an illustration for explanation of an optical path in the optical member OP and the liquid crystal display panel PNL of the liquid crystal display device DSP. In the figure, the polarizer POL, the λ/4-wave plate QW1, the liquid crystal layer 3, and the pixel electrode 52 (light-reflecting layer) are extracted from the optical member OP and the liquid crystal display panel PNL.

As shown in FIG. 8, the linearly polarized light released from the lighting unit LU is made incident on the polarizer POL. A plane of polarization (plane of oscillation) of the linearly polarized light is parallel to the second direction Y. For this reason, the linearly polarized light is transmitted through the polarizer POL. It should be noted that the scattered light, which is the environmental light, is also incident on the polarizer POL. As regards the environmental light, the linearly polarized light parallel to the second direction Y, of the scattered light, is transmitted through the polarizer POL. The λ/4-wave plate QW1 shifts a phase of the linearly polarized light of the second direction Y incident from the polarizer POL, by a quarter, and urges the light to be emitted to the liquid crystal layer 3 as right-hand circularly polarized light (hereinafter called clockwise circularly polarized light).

If the voltage is not applied to the liquid crystal layer 3, the liquid crystal layer 3 shifts the phase of the clockwise circularly polarized light incident from the λ/4-wave plate QW1 by a quarter wavelength, and urges the linearly polarized light of the second direction Y to be emitted to the pixel electrode 52. The liquid crystal layer 3 is configured such that its phase difference becomes an approximately quarter wavelength with a wavelength of 550 nm of high luminosity, of the visible light wavelength.

The linearly polarized light is reflected on the pixel electrode 52 and made incident on the liquid crystal layer 3 again. Then, the liquid crystal layer 3 shifts the phase of the incident polarized light by a quarter wavelength and is emitted to the λ/4-wave plate QW1 as the clockwise circularly polarized light. The λ/4-wave plate QW1 further shifts the phase of the clockwise circularly polarized light incident from the liquid crystal layer 3 by a quarter wavelength, and urges the linearly polarized light of the second direction Y to be emitted to the polarizer POL. The linearly polarized light and the transmission axis AXb of the polarizer POL are parallel to each other. For this reason, the light taken from the lighting unit LU and the like and reflected on the pixel electrode 52 is transmitted through the polarizer POL, in the off status (white display).

In contrast, if the voltage is applied to the liquid crystal layer 3, the liquid crystal layer 3 urges the light incident from the λ/4-wave plate QW1 to be emitted to the pixel electrode 52 while maintaining a polarized status of the light. When the clockwise circularly polarized light is made incident on the pixel electrode 52, the light is reflected to be left-hand circularly polarized light (hereinafter called counterclockwise circularly polarized light) and made incident on the liquid crystal layer 3 again. Then, the liquid crystal layer 3 maintains the polarized status of the incident light and urges the light to be emitted to the λ/4-wave plate QW1 as the counterclockwise circularly polarized light. The λ/4-wave plate QW1 shifts the phase of the counterclockwise circularly polarized light incident from the liquid crystal layer 3 by a quarter wavelength, and urges the linearly polarized light of the first direction X to be emitted to the polarizer POL. The linearly polarized light and the transmission axis AXb of the polarizer POL are orthogonal to each other. For this reason, the light taken from the lighting unit LU and the like and reflected on the pixel electrode 52 is absorbed into the polarizer POL, in the on status (black display).

The liquid crystal display panel PNL may use the normally-black mode, unlike the present embodiment. The normally-black mode is a mode in which the liquid crystal display panel PNL becomes black display in the off status of applying no voltage to the liquid crystal layer 3.

Next, the lighting unit LU will be explained. Three types of lighting units will be explained hereinafter as examples of the lighting unit which can be employed for the lighting unit LU of the present embodiment.

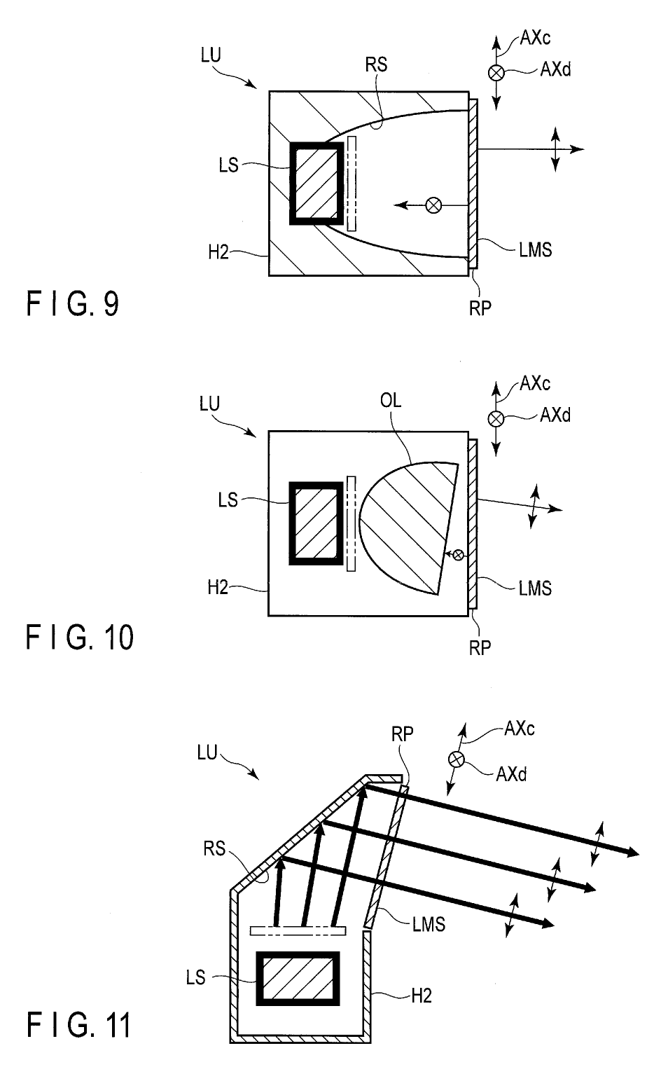

FIG. 9 is a cross-sectional view showing example 1 of the lighting unit LU.

As shown in FIG. 9, the lighting unit LU is a reflector-type lighting unit. The lighting unit LU comprises a light source LS, a housing H2, a reflective polarizer RP, and a light release surface LMS. A generally known light source such as a light-emitting diode, which is configured to emit light, can be used as the light source LS. The housing H2 accommodates the light source LS. The housing H2 has a light-reflecting surface RS on a plane of the side surrounding the light source LS.

The reflective polarizer RP has the transmission axis AXc and the axis AXd orthogonal to the transmission axis AXc. A dual brightness enhancement film (DBEF), a wire-grid polarizer or the like can be used as the reflective polarizer RP. The reflective polarizer RP transmits the linearly polarized light parallel to the transmission axis AXc, of the light incident from the light source LS side, and reflects the linearly polarized light parallel to the axis AXd. The reflective polarizer RP may further reflect the circularly polarized light, of the light incident from the light source LS side. A plane of polarization (plane of oscillation) of the linearly polarized light emitted from the lighting unit LU is parallel to a plane including the transmission axis AXc and a normal direction of the reflective polarizer RP.

The lighting unit LU is configured to return the light reflected on the reflective polarizer RP to the light source LS side and reuse the light. The efficiency of use of the light at the lighting unit LU can be thereby improved. The reflective polarizer RP is located in the middle of an optical path between the light source LS and the light release surface LMS.

In example 1, the reflective polarizer RP is located outside the housing H2, and one of the surfaces of the reflective polarizer RP closer to the optical member OP is the light release surface LMS. However, the position of the reflective polarizer RP is not limited to example 1 but can be variously modified, and the reflective polarizer RP needs only to be located in the middle of the optical path. For example, the reflective polarizer RP may not be disposed outside the housing H2, but may be disposed in front of the light source LS, inside the housing H2, as represented by a two-dot-chained line in the figure. In this case, an air layer may be or may not be interposed between the light source LS and the reflective polarizer RP.

FIG. 10 is a cross-sectional view showing example 2 of the lighting unit LU.

As shown in FIG. 10, the lighting unit LU is a lens-type lighting unit. The lighting unit LU comprises the light source LS, the housing H2, an optical lens OL, the reflective polarizer RP, and the light release surface LMS. The housing H2 accommodates the light source LS and the optical lens OL.

The reflective polarizer RP has the transmission axis AXc and the axis AXd orthogonal to the transmission axis AXc. A plane of polarization of the linearly polarized light released from the lighting unit LU is parallel to a plane including the transmission axis AXc and a normal direction of the reflective polarizer RP.

The lighting unit LU is configured to return the light reflected on the reflective polarizer RP to the light source LS side and reuse the light. The reflective polarizer RP is located in the middle of an optical path between the light source LS and the light release surface LMS.

In example 2, the reflective polarizer RP is located outside the housing H2, and one of the surfaces of the reflective polarizer RP closer to the optical member OP is the light release surface LMS. However, the position of the reflective polarizer RP is not limited to example 2 but can be variously modified, and the reflective polarizer RP needs only to be located in the middle of the optical path. For example, the reflective polarizer RP may be disposed between the light source LS and the optical lens OL, inside the housing H2, as represented by a two-dot-chained line in the figure.

FIG. 11 is a cross-sectional view showing example 3 of the lighting unit LU.

As shown in FIG. 11, the lighting unit LU is a reflector-type lighting unit. The lighting unit LU comprises the light source LS, the housing H2, the reflective polarizer RP, and the light release surface LMS. The housing H2 accommodates the light source LS. The housing H2 accommodates the light source LS. The housing H2 has a light-reflecting surface RS on a plane of the side on which the light is emitted from the light source LS. For this reason, the light reflected on the light-reflecting surface RS is emitted toward the light release surface LMS.

The reflective polarizer RP has the transmission axis AXc and the axis AXd orthogonal to the transmission axis AXc. The reflective polarizer RP transmits the linearly polarized light parallel to the transmission axis AXc, of the light incident from the light-reflecting surface RS side, and reflects the linearly polarized light parallel to the axis AXd.

The lighting unit LU is configured to return the light reflected on the reflective polarizer RP to the light source LS side and reuse the light. The reflective polarizer RP is located in the middle of an optical path between the light source LS and the light release surface LMS.

In example 3, the reflective polarizer RP is located outside the housing H2, and one of the surfaces of the reflective polarizer RP closer to the optical member OP is the light release surface LMS. However, the position of the reflective polarizer RP is not limited to example 3 but can be variously modified, and the reflective polarizer RP needs only to be located in the middle of the optical path. For example, the reflective polarizer RP may not be disposed outside the housing H2, but may be disposed between the light source LS and the light-reflecting surface RS, inside the housing H2, as represented by a two-dot-chained line in the figure.

As explained above, each of three types of lighting units LU comprises the reflective polarizer RP. However, the lighting unit LU may comprise a polarizer having the transmission axis AXc and an absorption axis orthogonal to the transmission axis AXc instead of the reflective polarizer RP. In other words, the lighting unit LU may not be configured to urge the light to be reflected on the polarizer and to reuse the light.

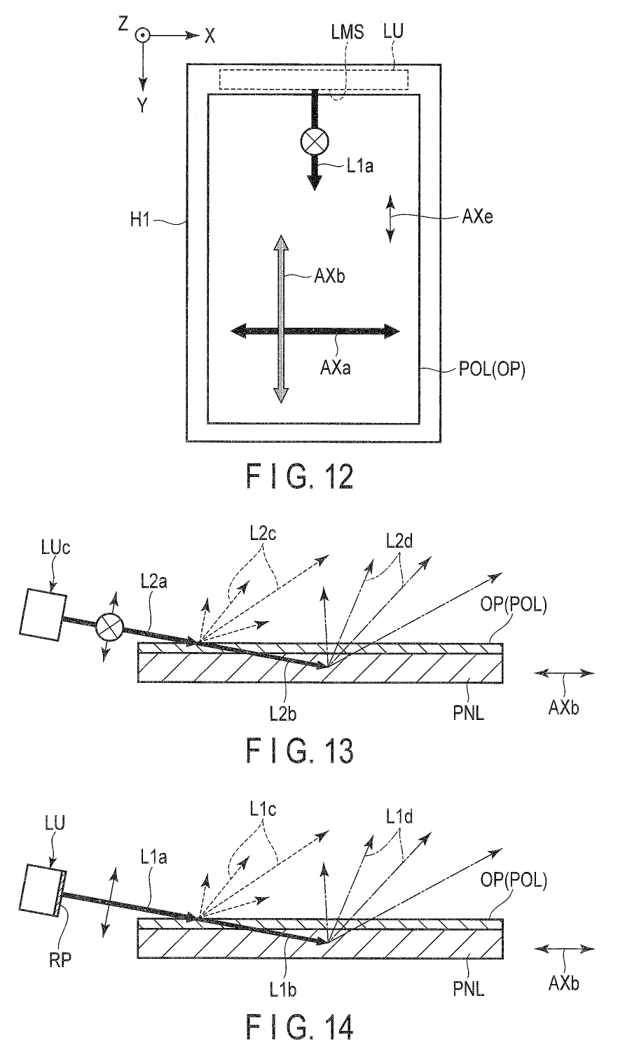

Next, a relationship between the linearly polarized light released from the lighting unit LU, and the absorption axis AXa and the transmission axis AXb of the polarizer POL will be explained. FIG. 12 is a front view showing the liquid crystal display device DSP, illustrating linearly polarized light L1a released from the lighting unit LU, the absorption axis AXa and the transmission axis AXb of the polarizer POL, and the like.

As shown in FIG. 12, a plane of polarization of the linearly polarized light L1a released from the lighting unit LU is parallel to a plane including the second direction Y and the third direction Z. An imaginary axis at which the plane of polarization of the linearly polarized light L1a intersects the polarizer POL is referred to as an axis AXe. The axis AXe may face the transmission axis AXb side rather than the absorption axis AXa. For this reason, the axis AXe may not be parallel to the transmission axis AXb. In the present embodiment, the axis AXe is parallel to the transmission axis AXb. In other words, the plane of polarization of the linearly polarized light L1a is parallel to the transmission axis AXb. In addition, in the present embodiment, the lighting unit LU is configured to emit the linearly polarized light L1a having high directivity. In this case, the polarization direction of the linearly polarized light L1a is substantially in agreement with the axis Axe.

The light release surface LMS of the lighting unit LU may be located in any direction to the optical member OP. In the present embodiment, the light release surface LMS is located on the upper front side of the optical member OP. The light release surface LMS is located in a plane including the transmission axis AXb and the normal line of the optical member OP (polarizer POL). When the liquid crystal display device DSP is seen from the front surface, the lighting unit LU is located not to block the optical member OP and the liquid crystal display panel PNL. When the liquid crystal display device DSP is seen from the observer's line of sight, the lighting unit LU may be located not to block the optical member OP and the liquid crystal display panel PNL.

Next, variation in energy (quantity) of the light released from the lighting unit LU will be explained. Variation in energy of the light released from the lighting unit LU of the present embodiment will be explained. In addition, variation in energy of the light released from the lighting unit LUc of the comparative example will also be explained for comparison with the present embodiment.

First, use of the lighting unit LUc of the comparative example will be explained.

FIG. 13 is a cross-sectional view showing the lighting unit LUc, the optical member OP and the liquid crystal display panel PNL of the liquid crystal display device of the comparative example, for explanation of variation in energy of the light released from the lighting unit LUc.

As shown in FIG. 13, the lighting unit LUc is different from the lighting unit LU of the present embodiment with respect to a feature of not comprising a polarizer such as the reflective polarizer RP. It should be noted that the optical member OP and the liquid crystal display panel PNL of the comparative example are the same as the optical member OP and the liquid crystal display panel PNL of the present embodiment.

Light having orientation within a certain angle range is released (emitted) from the lighting unit LUc. To adjust the reflectance in the plane, the lighting unit LUc is urged to intentionally have energy distribution. This is because the lighting unit LUc maintains uniformity of the light source efficiency and the display. The lighting unit LUc releases scattering light L2a, which is the unpolarized light. The energy of the scattering light L2a is assumed to be 100%. A polarization component parallel to the transmission axis AXb, of the scattering light L2a, is transmitted through the polarizer POL but the other components are absorbed into the polarizer POL. Since 50% of the scattering light L2a are absorbed into the polarizer POL, the energy of transmitted light L2b which is transmitted through the polarizer POL, of the scattering light L2a, is 50%.

In addition, a scattering component on the surface of the optical member OP, of the scattering light L2a, does not depend on the polarized status of the incident light. For example, the energy of first reflected light L2c reflected on the surface of the optical member OP, of the scattering light L2a, is assumed to be 1%. This indicates that the reflectance of the scattering light L2a on the surface of the optical member OP is 1% and the light scatters to the side on which the images are displayed. In other words, this indicates that as the energy of the scattering light L2a released from the lighting unit LUc is higher, the energy of the first reflected light L2c reflected as seen from a direction vertical to the surface of the optical member OP becomes higher.

The energy of second reflected light L2d obtained when the transmitted light L2b is reflected on the pixel electrode 52 and transmitted through the optical member OP is assumed to be 2.5%. The second reflected light L2d is a positive reflection component of the scattering light L2a. Variation in the energy of the light released from the lighting unit LUc is as follows:
Energy of scattering light L2a . . . 100%
Energy of transmitted light L2b . . . 50%
Energy of first reflected light L2c . . . 1%
Energy of second reflected light L2d . . . 5.0% (at white display)
Energy of second reflected light L2d . . . 0.25% (at black display)

A contrast ratio based on the first reflected light L2c and the second reflected light L2d is 4.8. The energy of the first reflected light L2c depends on the white display or black display.

Next, use of the lighting unit LU of the present embodiment will be explained.

FIG. 14 is a cross-sectional view showing the lighting unit LU, the optical member OP and the liquid crystal display panel PNL of the liquid crystal display device of the present embodiment, for explanation of variation in energy of the light released from the lighting unit LU.

As shown in FIG. 14, the lighting unit LU releases the linearly polarized light L1a. Since the energy of the scattered light L2a is assumed to be 100%, the energy of the linearly polarized light L1a is 50%. Since the linearly polarized light L1a is a polarization component parallel to the transmission axis AXb, the light is transmitted through the polarizer POL. The energy of the transmitted light L1b transmitted through the polarizer POL is 50%.

In addition, since the energy of the first reflected light L2c is assumed to be 1%, the energy of the first reflected light L1c reflected on the surface of the optical member OP, of the linearly polarized light L1a, is 0.5%. Since the energy of the second reflected light L2d is assumed to be 2.5%, the energy of the second reflected light L1d obtained after the transmitted light L1b is reflected on the pixel electrode 52 and transmitted through the optical member OP is also 2.5%.

Variation in the energy of the light released from the lighting unit LU is as follows:
Energy of linearly polarized light L1a . . . 50%
Energy of transmitted light L1b . . . 50%
Energy of first reflected light L1c . . . 0.5%
Energy of first reflected light L1d . . . 5.0% (at white display)
Energy of second reflected light L1d . . . 0.25% (at black display)

A contrast ratio based on the first reflected light L1c and the second reflected light L1d is 7.3.

It can be understood from the above that since the second reflected light L1d and the second reflected light L2d have the same energies, the energy of the linearly polarized light L1a is half of the energy of the scattered light L2a. It can also be understood that the energy of the first reflected light L1c is half of the energy of the first reflected light L2c. In the present embodiment, the energy of the light (first reflected light L1c) reflected to the observer side can be reduced as the energy of the light (linearly polarized light L1a) released from the lighting unit LU can be reduced. For this reason, more desirable black display can be performed with excellent contrast property in the present embodiment than in the comparative example.

When a foreign matter which becomes a bright spot (point defect) is attached to the surface of the optical member OP, too, the energy of the light released from the lighting unit LU is desirably reduced since the energy of the light scatted by the foreign matter can be reduced and the foreign matter can hardly be recognized visually.

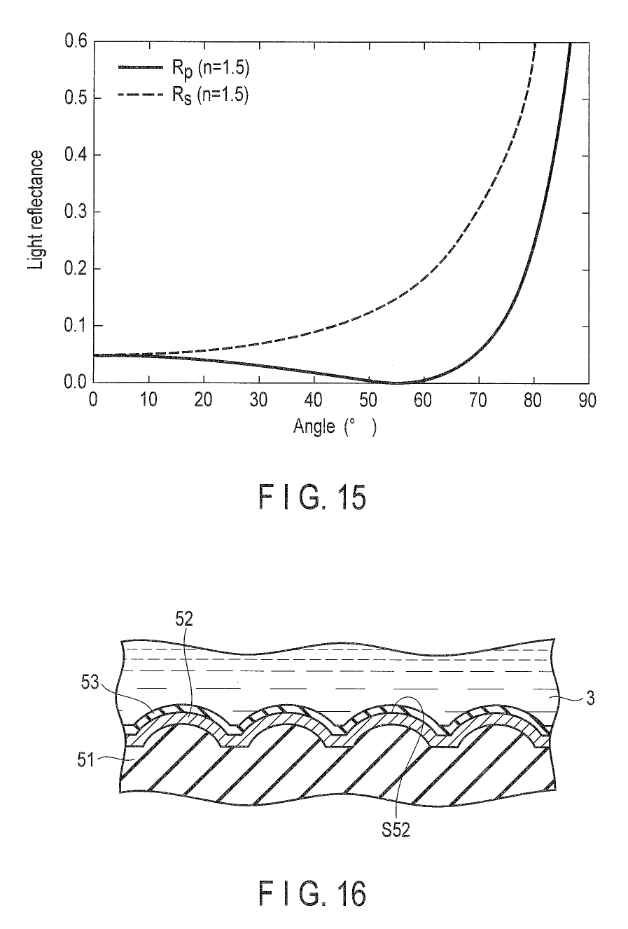

Next, a relationship between the incident angle and the light reflectance in a case where the light is made incident on an arbitrary medium will be explained. FIG. 15 is a graph showing variation in a light reflectance at an incident angle on an arbitrary medium.

As shown in FIG. 15, a medium having a refractive index n of 1.5 is used. An angle of the horizontal axis is a tilt angle from the normal line of the incident surface of the medium. Rp represents a reflectance of p polarization of the light reflected on the medium, and Rs represents a reflectance of s polarization of the light reflected on the medium.

As understood from FIG. 15, the variation in the light reflectance is smaller within a wide angle range and the reflection is more suppressed at the p polarization than at the s polarization. From the above point of view, too, it is desirable to adjust the position of the light release surface LMS of the lighting unit LU and adjust the direction of the linearly polarized light Lla, similarly to the present embodiment. In other words, if the light release surface LMS and the optical member OP are in a positional relationship as shown in FIG. 1 and FIG. 12, the plane of polarization of the linearly polarized light L1a is desirably parallel to not the first direction X, but the second direction Y. The light reflectance on the surface of the optical member OP can be thereby suppressed.

According to the liquid crystal display device of the first embodiment configured as described above, the liquid crystal display device DSP comprises the optical member OP, the liquid crystal display panel PNL and the lighting unit LU. The optical member OP comprises a polarizer POL having an absorption axis AXa and a transmission axis AXb. The liquid crystal display panel PNL includes a pixel electrode 52 (light-reflecting layer) and a liquid crystal layer 3 located between the pixel electrode 52 and the optical member OP. The lighting unit LU is located on the side opposite to the optical member OP with reference to the liquid crystal display panel PNL to release the linearly polarized light L1a transmitted through the polarizer POL to the polarizer POL side. A plane of polarization of the linearly polarized light L1a is parallel to the transmission axis AXb of the polarizer POL.

For this reason, the liquid crystal display device DSP capable of improving the display quality when using the lighting unit LU can be obtained. For example, the contrast property can be improved and, if a foreign matter is present before the optical member OP, the bright spot (point defect) can be made inconspicuous. If the lighting unit LU is configured to reuse the light, the efficiency of use of the light at the lighting unit LU can be improved.

### Second Embodiment

Next, a liquid crystal display device of a second embodiment will be described. The liquid crystal display device DSP of the present embodiment is different from the liquid crystal display device of the first embodiment with respect to feature that a pixel electrode 52 is formed to have an uneven surface and that an optical member OP is formed without a light diffusion film DIF1. FIG. 16 is a cross-sectional view showing several parts of an array substrate 1 in the liquid crystal display device DSP of the present embodiment, illustrating a fifth insulating film 51, a pixel electrode 52, an alignment film 53 and a liquid crystal layer 3.

As shown in FIG. 16, the pixel electrode 52 (light-reflecting layer) has an uneven light-reflecting surface S52 on the side opposed to the liquid crystal layer 3. For this reason, the pixel electrode 52 can diffuse and reflect the incident light. To obtain the pixel electrode 52, the fifth insulating film 51 serving as an underlayer is patterned to be uneven when the film is formed, in the present embodiment.

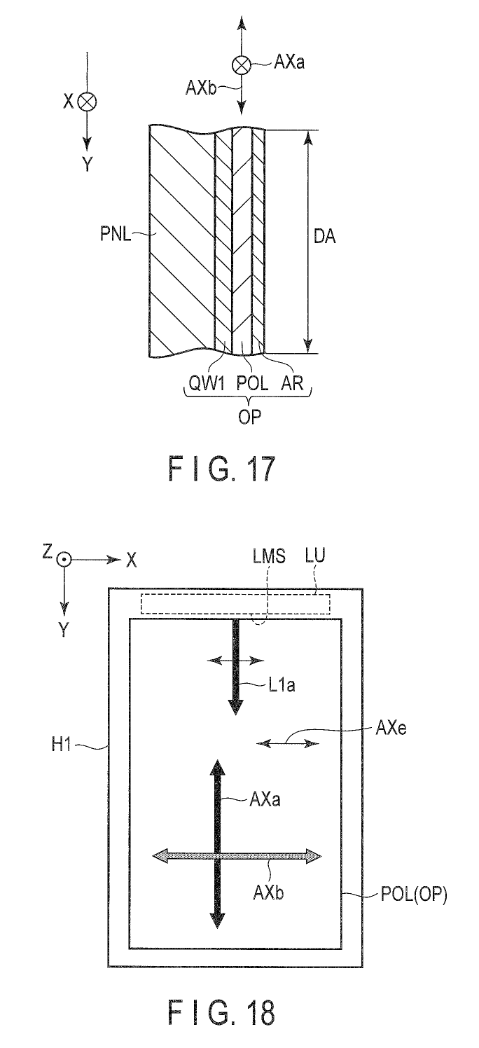

FIG. 17 is a cross-sectional view showing the liquid crystal display panel PNL and the optical member OP of the liquid crystal display device DSP of the present embodiment.

As shown in FIG. 17, the optical member OP comprises a λ/4-wave plate QW1, a polarizer POL, and an anti-reflective layer AR. The optical member OP of the present embodiment is formed without the light diffusion film DIF1, unlike the optical member OP shown in FIG. 7.

In the liquid crystal display device of the second embodiment configured as described above, too, the same advantages as those of the first embodiment can be obtained. For example, since the pixel electrode 52 has the uneven light-reflecting surface S52, the liquid crystal display panel PNL itself can diffuse and reflect the light.

### Third Embodiment

Next, a liquid crystal display device of a third embodiment will be described. The liquid crystal display device DSP of the present embodiment is different from the liquid crystal display device of the first embodiment with respect to a direction of linearly polarized light L1a, and an absorption axis AXa and a transmission axis AXb of a polarizer POL. FIG. 18 is a front view showing the liquid crystal display device DSP of the present embodiment, illustrating the linearly polarized light L1a emitted from a lighting unit LU, the absorption axis AXa and the transmission axis AXb of the polarizer POL, and the like.

As shown in FIG. 18, the absorption axis AXa is parallel to the second direction Y, and the transmission axis AXb is parallel to the first direction X. A plane of polarization of the linearly polarized light L1a emitted from the lighting unit LU is parallel to a plane including the first direction X. The axis AXe may face the transmission axis AXb side rather than the absorption axis AXa. In the present embodiment, the axis AXe is parallel to the transmission axis AXb. In other words, the plane of polarization of the linearly polarized light L1a is parallel to the transmission axis AXb.

The light release surface LMS of the lighting unit LU may be located in any direction to the optical member OP. In the present embodiment, the light release surface LMS is located on the upper front side of the optical member OP. The light release surface LMS is located in a plane including the absorption axis AXa and the normal line of the optical member OP (polarizer POL). In addition, in the present embodiment, the lighting unit LU is configured to emit the linearly polarized light L1a having high directivity. In this case, the polarization direction of the linearly polarized light L1a is substantially in agreement with the axis Axe.

In the liquid crystal display device of the third embodiment configured as described above, too, the same advantages as those of the first embodiment can be obtained since the lighting unit LU can emit the linearly polarized light L1a transmitting the polarizer POL toward the polarizer POL side.

### Fourth Embodiment

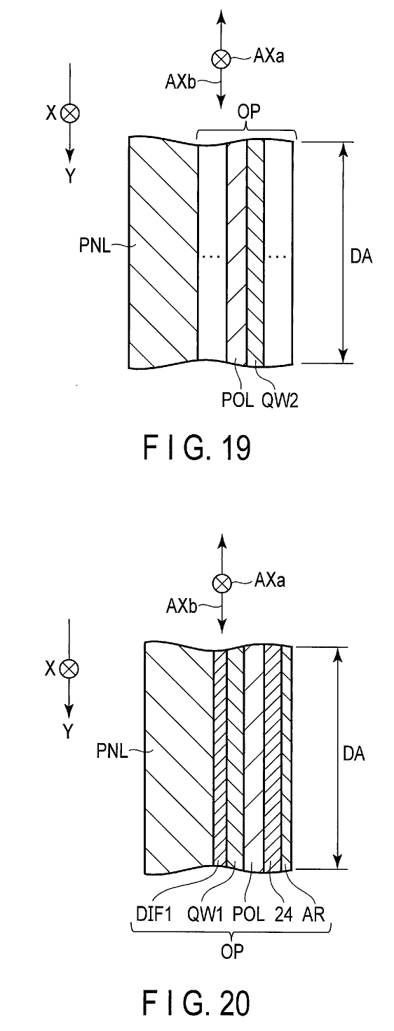

Next, a liquid crystal display device of a fourth embodiment will be described. The liquid crystal display device DSP of the present embodiment is different from the liquid crystal display device of the first embodiment with respect to feature that the optical member OP further comprising a second λ/4-wave plate. FIG. 19 is a cross-sectional view showing a liquid crystal display panel PNL and an optical member OP of the liquid crystal display device DSP of the present embodiment.

As shown in FIG. 19, the optical member OP may further comprise a λ/4-wave plate QW2 as a second λ/4-wave plate. The λ/4-wave plate QW2 is located on a side opposite to the liquid crystal display panel PNL with respect to a polarizer POL. In the present embodiment, the λ/4-wave plate QW2 is disposed adjacent to the polarizer POL. The λ/4-wave plate QW2 can urge the linearly polarized light L1a to be emitted to the polarizer POL while changing the polarized status or urge the light to be emitted to the observer's side while changing the polarized status of the light incident from the polarizer POL side.

For example, the images can be visually recognized by an observer wearing polarized glasses by applying the λ/4-wave plate QW2 of the present embodiment to the liquid crystal display device DSP shown in FIG. 18. If the λ/4-wave plate QW2 of the present embodiment is not applied to the liquid crystal display device DSP shown in FIG. 18, the transmission axis AXb of the polarizer POL and an absorption axis of the polarized glasses can easily match the first direction X. For this reason, the observer wearing polarized glasses can hardly recognize the images visually.

In the liquid crystal display device of the fourth embodiment configured as described above, too, the same advantages as those of the first embodiment can be obtained.

### Fifth Embodiment

Next, a liquid crystal display device of a fifth embodiment will be described. The liquid crystal display device DSP of the present embodiment is different from the liquid crystal display device of the first embodiment with respect to a feature that an optical member OP further comprises a second light diffusion film. FIG. 20 is a cross-sectional view showing a liquid crystal display panel PNL and an optical member OP of the liquid crystal display device DSP of the present embodiment.

As shown in FIG. 20, the optical member OP further comprises a light diffusion layer 24 as a second light diffusion film. The light diffusion layer 24 is located on a side opposite to the liquid crystal display panel PNL with respect to a polarizer POL.

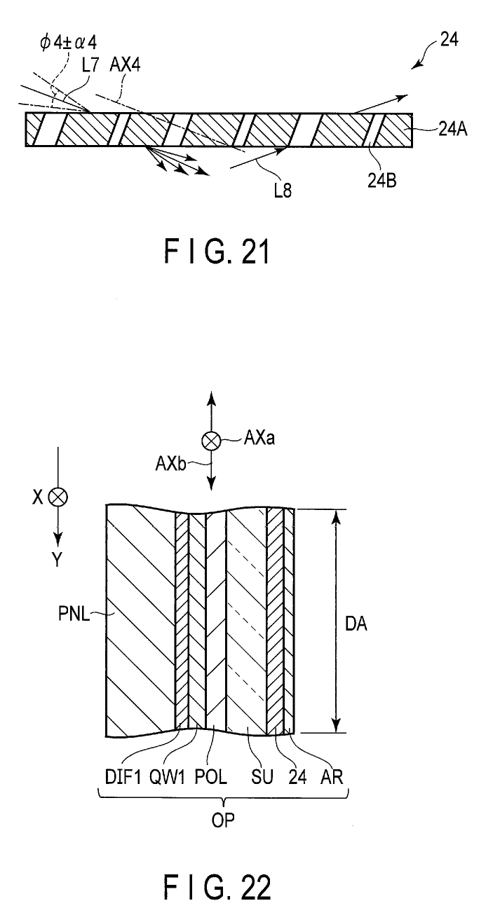

FIG. 21 is a cross-sectional view showing the light diffusion layer 24 shown in FIG. 20.

As shown in FIG. 21, the light diffusion layer 24 is an anisotropic diffusion layer which strongly diffuses the light incident within a specific angle range from a specific orientation at a position of a light release surface LMS of a lighting unit LU and which diffuses the light incident within the other angle range relatively weakly. A light diffusion layer 24 disclosed in JP 2013-41107A can be used as the light diffusion layer 24.

The light diffusion layer 24 is, for example, an anisotropic diffusion layer which relatively strongly diffuses light of a component incident within a specific angle range φ±α4 from a specific orientation, of light L7 incident from an upper surface side of the light diffusion layer 24, and which diffuses the light of the other components (for example, light L8 in the figure) relatively weakly. The light diffusion layer 24 further includes a center-of-diffusion axis corresponding to a specific angle within a specific angle range φ4±α4. For example, the light diffusion layer 24 includes a center-of-diffusion axis AX4 at which when the light L7 is incident at an angle of incidence φ4 from the upper surface side of the light diffusion layer 24, the diffusion of the light L7 reaches a peak.

The situation “when the light L7 is incident at an angle of incidence φ4, the diffusion of the light L7 reaches a peak” indicates that when the light L7 is diffused by the light diffusion layer 24 and emitted to the upper surface of the light diffusion layer 24, the incident angle of the light L7 at which the diffusion range of the diffused light becomes maximum is φ4. The center-of-diffusion axis AX4 therefore represents an axis extending in a direction which intersects the normal line of the light diffusion layer 24 at angle φ4. The angle φ4 of the center-of-diffusion axis AX4 is approximately 70°.

The light diffusion layer 24 is constituted to include, for example, two types of regions (first region 24A and second region 24B) different in refractive index. The light diffusion layer 24 may have a louver structure or a columnar structure though not illustrated. The first region 24A and the second region 24B extend in a thickness direction of the light diffusion layer 24 and are angled to a predetermined direction. The light diffusion layer 24 is formed by, for example, irradiating a resin sheet which is a mixture of two or more photopolymerizable monomers or oligomers different in refractive index with ultraviolet rays from an oblique direction. The light diffusion layer 24 may have a structure different from the above-explained structures and may be manufactured in a manner different from the above-explained manner.

The second light diffusion film of the present embodiment is the light diffusion layer 24 but is not limited to this and can be variously modified. For example, the second light diffusion film may be replaced with deposited light diffusion layers. For example, light diffusion layers 21 to 24 disclosed in JP 2013-41107A can be used as the light diffusion layers.

In the liquid crystal display device of the fifth embodiment configured as described above, too, the same advantages as those of the first embodiment can be obtained. Use of the light diffusion layer 24 can suppress the lowering of the luminance level of the display images even in, for example, a region in the display area DA which is located remote from the light release surface LMS and in which the linearly polarized light L1a is made incident on the optical member OP at an incident angle of approximately 70°.

### Sixth Embodiment

Next, a liquid crystal display device of a sixth embodiment will be described. The liquid crystal display device DSP of the present embodiment is different from the liquid crystal display device of the fifth embodiment with respect to a feature that an optical member OP further comprises a transparent substrate SU. FIG. 22 is a cross-sectional view showing a liquid crystal display panel PNL and an optical member OP of the liquid crystal display device DSP of the present embodiment.

As shown in FIG. 22, the optical member OP may further comprise the transparent substrate SU. The transparent substrate SU is formed of a transparent material such as glass. The position of the transparent substrate SU in the optical member OP is not limited particularly. For example, the transparent substrate SU may be interposed between an anti-reflective layer AR and a light diffusion layer 24. However, the transparent substrate SU is desirably interposed between the light diffusion layer 24 and a polarizer POL.

In the liquid crystal display device of the sixth embodiment configured as described above, too, the same advantages as those of the fifth embodiment can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

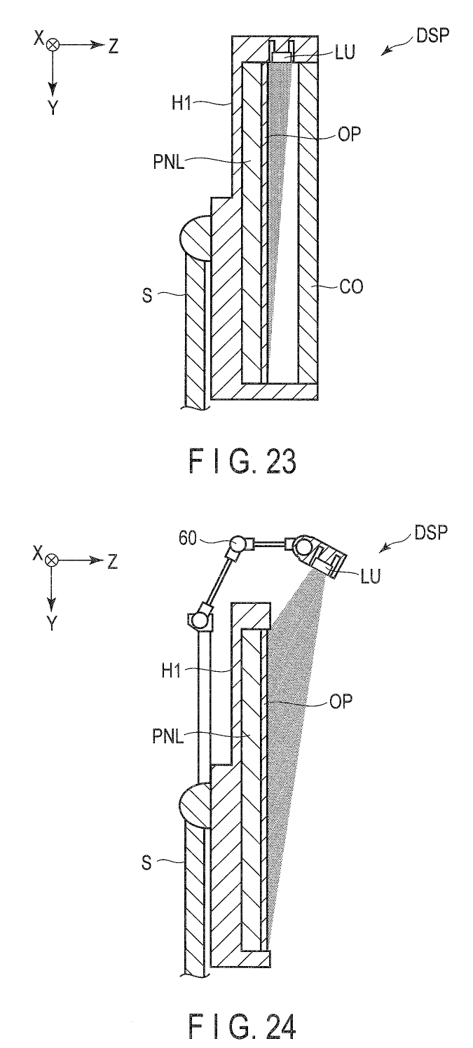

As shown in FIG. 23, for example, the liquid crystal display device DSP may comprise a cover member CO. The cover member CO is formed of a transparent material such as glass. Space between the optical member OP and the cover member CO is an air layer, which is an optical path of linearly polarized light L1a. A functional film for improving the optical property (i.e., suppressing the light reflection) may be disposed on an interface between the optical member OP and the air layer or an interface between the cover member CO and the air layer. The cover member CO and the liquid crystal display panel PNL can be protected by using the cover member CO.

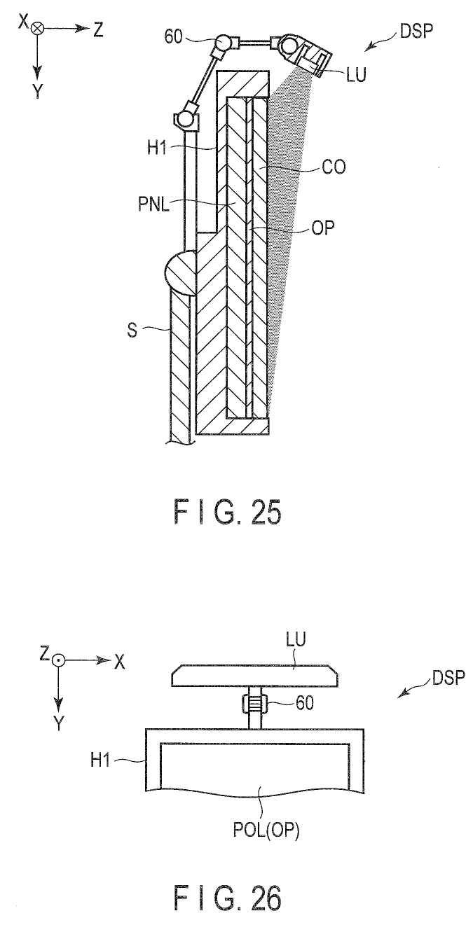

The lighting unit LU may not be attached to a housing H1. For example, the lighting unit LU may not be attached to a housing H1, but may be attached to an arm 60 and supported as shown in FIG. 24. Even when the arm 60 is used, the cover member CO may be used as shown in FIG. 25. In the example illustrated in the figure, the cover member CO is stuck on the optical member OP, and an air layer is not present between the optical member OP and the cover member CO.

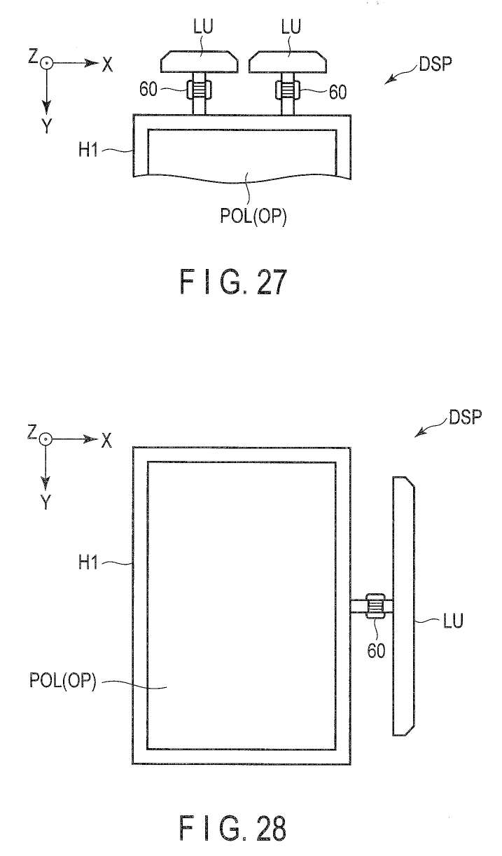

The liquid crystal display device DSP may be equipped with a single lighting unit LU as shown in FIG. 26 or two lighting units LU as seen in FIG. 27. Alternatively, the liquid crystal display device DSP may be equipped with three or more lighting units LU.

The lighting unit LU may not be disposed on an upper front side of the optical member OP and can be variously modified. Here, the upper front side is an upper part side of the screen. As shown in FIG. 28, for example, the lighting unit LU may be disposed on a front left side of the optical member OP. Here, the front left side is the right side as seen from the screen. In this case, the lighting unit LU is configured to release the linearly polarized light in a leftward direction and illuminate the liquid crystal display panel PNL.

The lighting unit LU may be disposed independently of the liquid crystal display device DSP. The lighting unit LU may be disposed independently of the housing H1 and a stand S. The lighting unit LU may be disposed on, for example, a ceiling, a wall or the like of the surrounding of a position at which the liquid crystal display device DSP is disposed. In this case, the liquid crystal display device DSP and lighting means such as the lighting unit LU may constitute a liquid crystal display system.

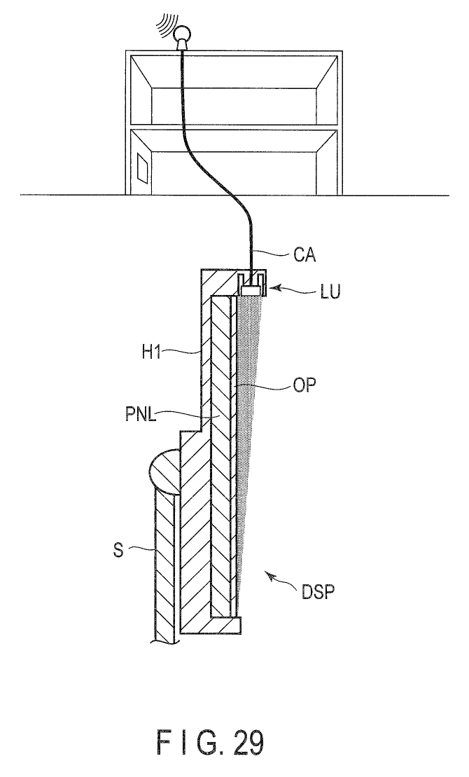

A light source of the lighting unit LU (lighting means) of the liquid crystal display device DSP may be external light. As shown in FIG. 29, for example, light collected outdoors may be guided to the lighting unit LU by an optical fiber CA. In this case, the lighting unit LU is equipped with a polarizer such as a reflective polarizer RP. Thus, even when the liquid crystal display device DSP or the liquid crystal display system is used indoors or an outside space where external light can hardly enter, the liquid crystal display device DSP can display the images by using external light in the daytime. A location where external light is collected is not particularly limited but the light can be collected in a building or a house and, if possible, on a telephone pole or the like.

The above-described liquid crystal display panel PNL has a structure corresponding to a TN mode as its display mode, but may have a structure corresponding to the other display modes. For example, the liquid crystal display panel PNL may have a structure corresponding to a mode using a longitudinal electric field mainly generated between main surfaces of the substrates, such as optically compensated bend (OCB) mode and vertical aligned (VA) mode. In the display mode using the longitudinal electric field, for example, the liquid crystal display panel PNL may have a structure in which the pixel electrode 52 is disposed on the array substrate 1 an the counter-electrode 42 is disposed on the counter-substrate 2. Alternatively, the liquid crystal display panel PNL may have a structure corresponding to an in-plane switching (IPS) mode mainly using a lateral electric field substantially parallel to the main surface of the substrate such as the fringe field switching (FFS) mode. In the display mode using the lateral electric field, for example, the liquid crystal display panel PNL may have a structure in which both the pixel electrode 52 and the counter-electrode 42 are disposed on the array substrate 1.

The liquid crystal display panel PNL is not limited to a reflective liquid crystal display panel, but may be a transflective liquid crystal display panel. In this case, the liquid crystal display device DSP comprises a backlight unit. The transreflective liquid crystal display panel PNL comprises a transmissive display function of displaying the images by selectively transmitting the light from the backlight unit, and a reflective display function of displaying the images by selectively reflecting the light from the lighting unit LU (lighting means). The above-described embodiments and modified example can be applied to not only the above-explained liquid crystal display device DSP and the liquid crystal display system, but also various types of liquid crystal display devices and liquid crystal display systems. It is needless to say that the above-described embodiments can be applied to middle or small liquid crystal display devices and large liquid crystal display devices without particular limitation.

What is claimed is:

1. A liquid crystal display device, comprising:
an optical member comprising a polarizer having an absorption axis and a transmission axis;
a liquid crystal display panel including a light-reflecting layer and a liquid crystal layer located between the light-reflecting layer and the optical member; and
a lighting unit located on a side opposite to the optical member with respect to the liquid crystal display panel to release linearly polarized light transmitted through the polarizer toward the polarizer side.

2. The liquid crystal display device of claim 1, wherein
an imaginary axis in which a plane of polarization of the linearly polarized light intersects the polarizer is oriented to the transmission axis side from the absorption axis.

3. The liquid crystal display device of claim 2, wherein
the plane of polarization of the linearly polarized light is parallel to the transmission axis.

4. The liquid crystal display device of claim 1, wherein
a light release surface of the lighting unit is located on a plane including the transmission axis and a normal line of the polarizer.

5. The liquid crystal display device of claim 1, wherein
the optical member further comprises a second λ/4-wave plate located on a side opposite to the liquid crystal display pane with respect to the polarizer.

6. The liquid crystal display device of claim 1, wherein
the optical member further comprises a second light diffusion film located on a side opposite to the liquid crystal display panel with respect to the polarizer, and
the second light diffusion film is an anisotropic diffusion layer strongly diffusing light made incident within a specific angle range from a specific orientation in which a light release surface of the lighting unit is located and diffusing light made incident within the other angle range relatively weakly.

7. The liquid crystal display device of claim 1, wherein
the lighting unit comprises a light source emitting light, a light release surface, and a reflective polarizer located in a middle of an optical path traveling from the light source to the light release surface and is configured to return light reflected on the reflective polarizer to the light source side and reuse the light.

8. The liquid crystal display device of claim 1, wherein
the liquid crystal display panel further includes a scanning line, a signal line, a switching element connected to the scanning line and the signal line, and a pixel electrode electrically connected to the switching element, and
the pixel electrode is the light-reflecting layer.

9. The liquid crystal display device of claim 1, wherein
the light-reflecting layer includes an uneven light-reflecting surface on a side opposed to the liquid crystal layer.

10. The liquid crystal display device of claim 9, wherein
the liquid crystal display panel further includes a scanning line, a signal line, a switching element connected to the scanning line and the signal line, and a pixel electrode electrically connected to the switching element, and
the pixel electrode is the light-reflecting layer.

11. The liquid crystal display device of claim 1, wherein
the optical member further comprises a first light diffusion film located between the polarizer and the liquid crystal display panel, and
the first light diffusion film is an isotropic diffusion layer or an anisotropic diffusion layer.

12. The liquid crystal display device of claim 1, wherein
the optical member further comprises a first λ/4-wave plate located between the polarizer and the liquid crystal display panel.

13. A liquid crystal display system comprising:
a liquid crystal display device comprising
an optical member comprising a polarizer having an absorption axis and a transmission axis, and
a liquid crystal display panel including a light-reflecting layer and a liquid crystal layer located between the light-reflecting layer and the optical member; and
a lighting unit disposed independently of the liquid crystal display device, and located on a side opposite to the optical member with respect to the liquid crystal display panel to release linearly polarized light transmitted through the polarizer toward the polarizer side.
